(19) United States
(12) Patent Application Publication
(10) Pub. No.: US 2017/0254901 A1
(43) Pub. Date: Sep. 7, 2017

(54) Carrier Phase Double Differencing GNSS Receiving System with Spatial Integrity Monitoring

(71) Applicant: Mitsubishi Electric Research Laboratories, Inc., Cambridge, MA (US)

(72) Inventor: Kyeong Jin Kim, Lexington, MA (US)

(73) Assignee: Mitsubishi Electric Research Laboratories, Inc., Cambridge, MA (US)

(21) Appl. No.: 15/062,625

(22) Filed: Mar. 7, 2016

(51) Int. Cl. G01S 19/20

(52) U.S. Cl. CPC G01S 19/20

(57) ABSTRACT

A method and system determines a reference receiver for carrier phase differencing in a global navigation satellite system by first receiving measurements from at least five satellites at a set of antennas of a set of receivers. Right-hand circular polarization is applied at a first subset of antennas of a first subset of receivers and left-hand circular polarization is applied at a second subset of the antennas of a second subset of receivers to produce first and second phase lock loop (PLL) outputs. Line-of-sight and non-line-of-sight detection are applied to the first and second PLL outputs to indicate a presence of multipath. Then, whether or not the first subset of receivers are affected by multipath and polarization changing impairments are output, and carrier phase double differencing is performed using carrier phase measurements to indicate which receiver is used as a reference receiver for the carrier phase double differencing.

### FIELD OF THE INVENTION

This invention relates generally to global navigation satellite system (GNSS) including spatially separated receivers, and more particularly to carrier phase double differencing GNSS receiving system with spatial integrity monitoring.

### BACKGROUND OF THE INVENTION

A carrier phase double differencing based global position system (GPS) can provide position solutions at centimeter level accuracy. Owing to recent achievement in the GNSS receiver design, the carrier phase double differencing has gained a lot of attentions for GNSS applications that require precise position solution. However, carrier phase measurements intrinsically include integer ambiguities that need to be resolved before the measurements are used. Without a reliable resolution solution, the accuracy of the position solution cannot be guaranteed.

As a conventional resolution solution, a relatively lengthy initialization can be used to estimate the integer ambiguity. That is, the initialization is required whenever loss of satellite signals happens. Although a precise position solution can be obtained, frequent initializations to resolve the integer ambiguity is a major limitation of the carrier phase double differencing to the problems where continuous satellite lock is hard to be maintained.

It is also required that the integer ambiguity resolution algorithm needs to signal the quality of accuracy of the position solution. The GNSS applications need to provide integrity warning when the system cannot guarantee that it is within a safety specification. In the conventional approach, the test statistics are formed from the residual of estimated position solutions, and then the magnitude of the statistics is compared with a threshold. If this magnitude is less than the threshold, then it is likely decided that no position error occurs. Otherwise, it is likely that position error occurs. In the conventional way, it is generally assumed that the residuals follow a Gaussian distribution. However, in reality, the residuals do not follow the Gaussian distribution and are affected by an un-modeled bias. Also, the residuals change temporally and spatially.

In U.S. Pat. No. 9,116,231, a fixed ambiguity set is used to determine a position estimate and position covariance estimate. Based on the estimated covariance, a measure of position quality is determined. In U.S. Pat. No. 8,427,365, the quality evaluator is applied to determine whether integer ambiguity set is resolved correctly.

In the conventional carrier phase double differencing approach, a fixed base station is used in the computation of the relative distance between this reference station to the other receiver. Because of its fixed location, a priori known position information is used as a reference, see U.S. Pat. No. 6,229,479. However, when a moving receiver is used as a reference there is uncertainty about which receiver is used as a reference receiver for the carrier phase double differencing. Also, there is a need to verify that this reference receiver should be reliable from spoofing and multipath.

### SUMMARY OF THE INVENTION

The embodiments of the invention provide a system and method for monitoring an integer ambiguity resolution for carrier phase double differencing receiver with spatial integrity.

The most difficulty in evaluating the quality of the integer ambiguity resolution and eventually estimated relative distance is that there is no appropriate distribution for the detected relative distance reflecting all possible abnormal conditions.

Because the conventional ratio test has restrictive usage, one needs to provide a method and system that covers general cases without limitation.

The method according to the embodiments uses a two-sample Kolmogorov-Smirnov (KS) test. With an available database for normal condition, where an integer ambiguity resolution is exact, so that the obtained position solution in sub-meter accuracy.

The method compares a set of estimated relative distances between two receivers obtained by the carrier phase double differencing, and then determine the maximum discrepancy of these relative distances over the database. And then compare it with the threshold, which is determined by the confidence level.

If the method uses information from the speed sensor, the method can determine the elevation angle rate over the speed. A constant in this ratio is related with the spoofing or multipath.

Applying these processes separately for each receiver, one can determine a reference receiver for the carrier phase double-differencing based position estimation.

### BRIEF DESCRIPTION OF THE DRAWINGS

FIG. 1 is a block diagram of a system and method FIG. 1 of a system and method for carrier phase double differencing according to embodiments of the invention;

FIG. 2 is a block diagram of a method for determining moving reference receiver for carrier phase double differencing receiver according to embodiments of the invention;

FIG. 3 is a block diagram for carrier phase double differencing with integrity monitoring according to embodiments of the invention; and

FIG. 4 is a chart of results for an example of a two-sample KS test used by embodiments of the invention.

### DETAILED DESCRIPTION OF THE PREFERRED EMBODIMENTS

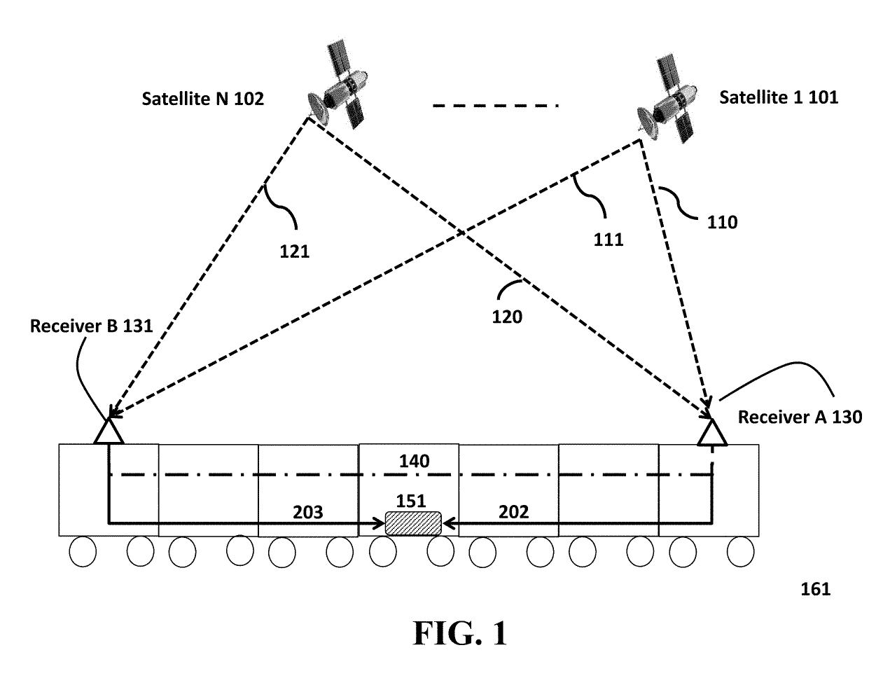

The embodiments of the invention provide a global navigation satellite system (GNSS) including spatially separated receivers. FIGS. 1-3 show block diagram of a system and method for carrier phase double differencing. In one example application the system controls a moving object 161, e.g., a train or vehicle. The system includes of a set of GNSS receivers 130 and 131 installed at different fixed locations on a train. These receivers are coupled by a tight time synchronization 140 between the receivers. For the carrier phase double differencing, at least five satellites 101-102 in view are used.

As used herein a set of receivers is defined as two or more receivers, and a subset of receivers is defined as one or more receivers. Received measurements 110, 111, 120, and 121 denote a set of carrier phase measurements, which intrinsically include a different integer ambiguity. The phase lock loop (PLL) outputs 202 and 203 from two GNSS receivers 130 and 131, are collected by the on board unit 151.

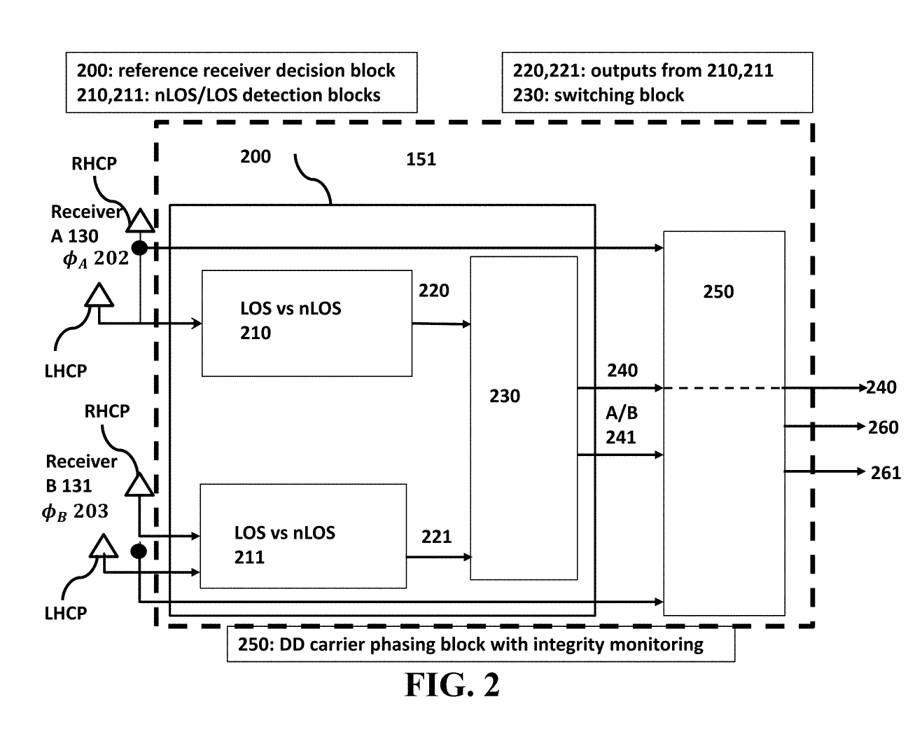

FIG. 2 shows the carrier phase double differencing integrating the integer ambiguity resolution monitoring and the carrier phase double differencing operating in block 250. For the determination of the moving reference receiver for carrier phase double differencing, we apply right-hand circular polarization (RHCP) and left-hand circular polarization LHCP antennas at the receivers 130 and 131. Having received two antennas outputs, line-of-sight (LOS) and non-line-of-sight (nLOS) detection blocks 210 and 211 output, respectively, 220 and 221 to indicate a presence of multipath. In block 230, we generate output 240 and 241, whether both receivers are affected by multipath and polarization changing impairments, that is 240 becomes zero, otherwise 240 becomes one and 241 becomes either 00, 01, or 10 to indicate that either receiver A 130 is not affected by them, receiver B 131 is not affected by them, or both receivers are not affected by the impairments. In block 250, the carrier phase double differencing is performed using two carrier phase measurements 202 and 203, and 240 and 241 indicating which receiver is used as a reference receiver for the double differencing.

For the multipath detection, we implemented the following idea. If the received carrier phase measurements 202 and 203 are not impaired by multipath, then the output from the RHCP antenna is greater than the LHCP antenna because every satellite transmits RHCP signals. Otherwise, the LHCP antenna generates a greater output than the RHCP antenna because a reflected multipath GPS signal changes its polarization.

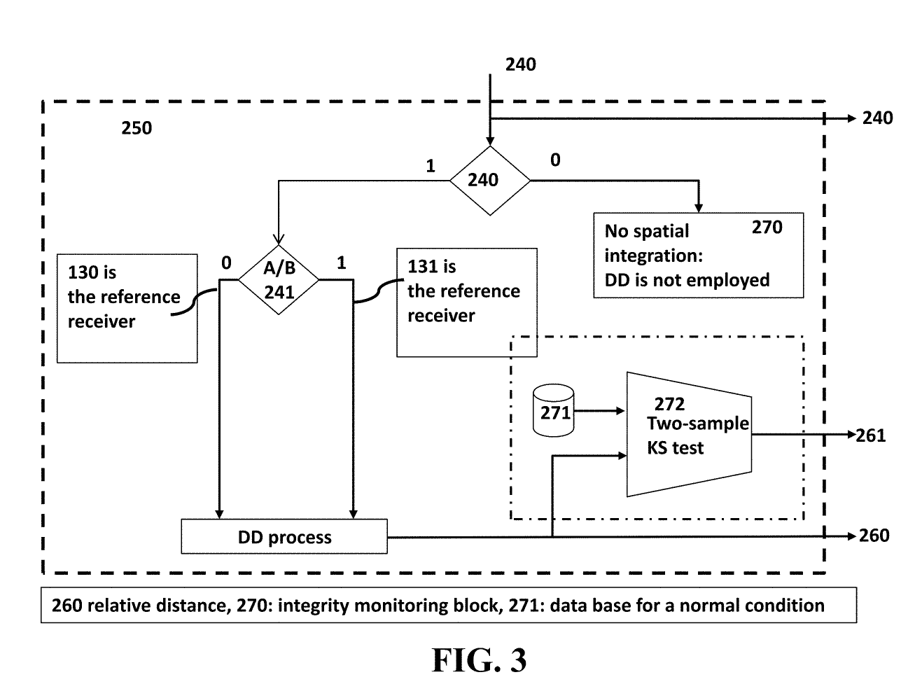

As shown in FIG. 3, based on the measurement 240, we first determine whether we apply the carrier phase double differencing. Because when the measurement 240 is zero, both receivers are simultaneously affected by multipath, both receivers are not able to serve as a reference receiver. Thus, the carrier phase double differencing is not used. When measurement 240 becomes one and measurement 241 is either 00, 01, and 10, then we select one reference receiver out of receivers 130 and 131. Then, we apply the carrier phase double differencing 280 using carrier phase measurements 202 and 203. The carrier phase double differencing block 280 outputs relative distance 260 after integer ambiguity resolution. This distance 260 is input to the integrity monitoring block 270, which constitutes the two-sample KS test 272 to evaluate the quality of the position estimation comparing with the database 271 for a normal condition. Depending on the maximum discrepancy of 260 with respect to the database 271, the two-sample KS test accepts the null hypothesis or rejects the hypothesis.

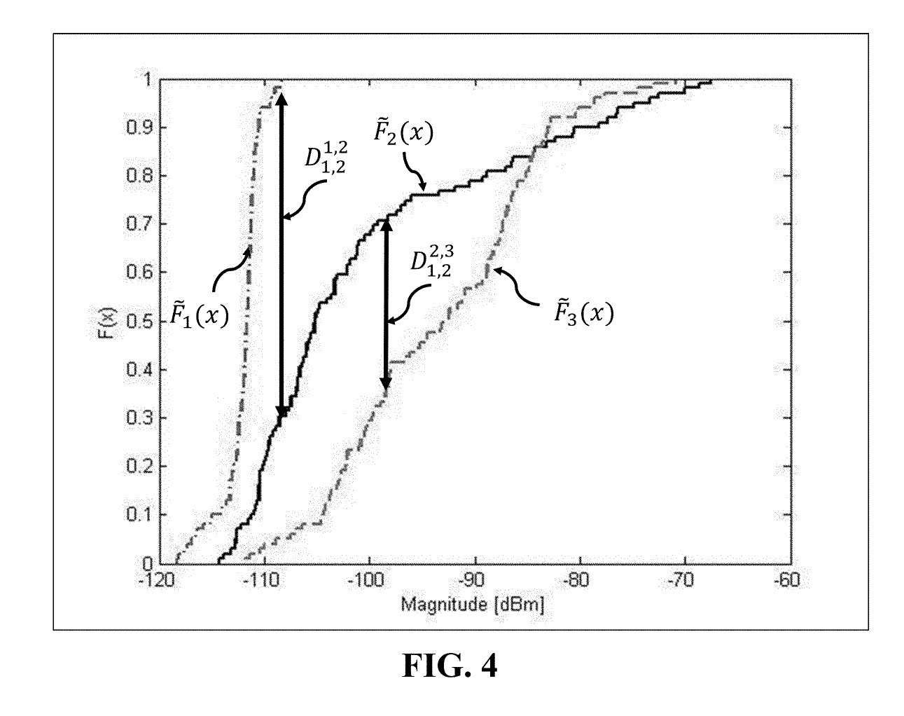

FIG. 4 is a chart of results for an example of a two-sample KS test. Maximum discrepancies D_{1,2}^{1,2} between \tilde{F}₁(x) and \tilde{F}₂(x) and D_{1,2}^{2,3} between \tilde{F}₂(x), and \tilde{F}₃ (X) can be determined by the two-sample KS test. Because D_{1,2}^{2,3}<D_{1,2}^{1,2}, the distribution \tilde{F}₂(X) is statistically more similar to \tilde{F}₃(X) than \tilde{F}₁(x).

The method uses a cluster of samples for a particular time window interval at each of the receivers. If the received carrier phase measurements are not impaired by multipath and spoofing, then the elevation angle changes due to satellite movement because a directional vector changes in time. Otherwise, the elevation angle does not change due to a constant directional vector. Thus, spoofing and multipath can be detected at both receivers.

For the relative distance samples x₁, x₂, . . . , x_{N}_{₁} with unknown empirical distribution Fₘ, this system forms the null hypothesis that Fₘ is equal to a particular distribution Fₙ, with the samples y₁, y₂, . . . , y_{N}_{₂}. The null hypothesis is defined by

Hₒ:Fₘ=Fₙ. (1)

An accompanying KS statistics is given by
Dₘₙ=\sqrt{Nₑ} max|Fₘ(x)−Fₙ (x)|, with

$${N}_{e} ≡ \frac{{N}_{1} {N}_{2}}{{N}_{1} + {N}_{2}} .$$

The decision rules is

$$δ = \{ \begin{matrix}{H}_{0} \text{:} \sqrt{{N}_{e}} {D}_{mn} \leq th \\ {H}_{1} \text{:} \sqrt{{N}_{e}} {D}_{mn} > th\end{matrix} , \qquad ( 2 )$$

where th depends on the significance level α which is given by
α=Pr(\sqrt{Nₑ}Dₘₙ≧th|H₀), where an asymptotic expression is given by

$$Pr ( \sqrt{{N}_{e}} {D}_{mn} \leq th \vert {H}_{0} ) \approx 1 - 2 {\sum }_{j = 1}^{∞} {( - 1 )}^{j - 1} {e}^{- 2 {{j}^{2} ( th )}^{2}} . \qquad ( 3 )$$

Thus, at a given significance level α (0<α<1), the threshold th can be determined. Based on this development, the null hypothesis is rejected at the confidence level α if

\sqrt{Nₑ}max|Fₘ(x)−Fₙ(x)|≧th,

otherwise, accept the null hypothesis that a set of relative distance samples are for the normal condition. That is, for different sample sizes for data base and a set of measurements (relative distance estimates), an optimum threshold, th, is determined at the desirable false-alarm probability.

Then, based on this threshold, determine whether a set of measurements represent normal condition or not. If a set of measurements come from normal condition, then a collected set of relative distance samples can provide precise sub-meter accuracy. Based on this test, signal 261 becomes one indicating that a relative distance estimate signal 260 is reliable, whereas when signal 261 becomes zero indicating that the relative distance estimate signal 260 is not reliable.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for determining a reference receiver for carrier phase differencing in a global navigation satellite system (GNSS), comprising:
receiving measurements from at least five satellites at a set of antennas of a set of receivers, wherein the set of antennas are arranged at fixed locations on a moving object;
applying right-hand circular polarization (RHCP) at a first subset of antennas of a first subset of receivers and left-hand circular polarization (LHCP) at a second subset of the antennas of a second subset of receivers to produce first and second phase lock loop (PLL) outputs;
applying line-of-sight (LOS) and non-line-of-sight (nLOS) detection to the first and second PLL outputs to indicate a presence of multipath;
outputting whether or not the first subset of receivers are affected by multipath and polarization changing impairments; and
performing carrier phase double differencing using carrier phase measurements to indicate which receiver is used as a reference receiver for the carrier phase double differencing.

2. The method of claim 1, further comprising:
performing a two-sample Kolmogorov-Smirnov (KS) test to detect normal or abnormal integer ambiguity resolution;
constructing a database for a normal condition;
determining an optimum threshold at a target false alarm probability based on statistics of the KS test to monitor a quality of the integer ambiguity resolution.

3. The method of claim 1, wherein the moving object is a train.

4. The method of claim 1, wherein the set of receivers are coupled by tight time synchronization.

5. A system for determining a reference receiver for carrier phase differencing in a global navigation satellite system (GNSS), comprising:
a set of antennas of a set of receivers configured to receive measurements from at least five satellites, wherein the set of antennas are arranged at fixed locations on a moving object;
a processor configured to apply right-hand circular polarization (RHCP) at a first subset of antennas of a first subset of receivers and left-hand circular polarization (LHCP) at a second subset of the antennas of a second subset of receivers to produce first and second phase lock loop (PLL) outputs, and to apply line-of-sight (LOS) and non-line-of-sight (nLOS) detection to the first and second PLL outputs to indicate a presence of multipath, and to output whether or not the first subset of receivers are affected by multipath and polarization changing impairments, and to perform carrier phase double differencing using carrier phase measurements to indicate which receiver is used as a reference receiver for the carrier phase double differencing.
